(19) United States
(12) Patent Application Publication
(10) Pub. No.: US 2023/0065647 A1
(43) Pub. Date: Mar. 2, 2023

(54) EMERGENCY SIREN DETECTION IN AUTONOMOUS VEHICLES

(71) Applicant: TUSIMPLE, INC., San Diego, CA (US)

(72) Inventors: Scott Douglas FOSTER, San Diego, CA (US); Neil M. OVERMON, Redwood City, CA (US); Erik Orlando PORTILLO, Sterling, VA (US); Zhujia SHI, San Diego, CA (US); Joyce TAM, Pleasanton, CA (US); Mohammad POORSARTEP, San Diego, CA (US); Christopher MILLER, San Diego, CA (US); Pengji DUAN, Tucson, AZ (US); Lingting GE, San Diego, CA (US); Navid SARMADNIA, San Diego, CA (US); Panqu PANQU WANG, San Diego, CA (US); Zhe HUANG, Pirrsburgh, PA (US)

(21) Appl. No.: 17/822,735

(22) Filed: Aug. 26, 2022

Related U.S. Application Data
(60) Provisional application No. 63/238,089, filed on Aug. 27, 2021.

(51) Int. Cl. G08G 1/0965; G08G 1/0967; G01S 15/58; G01S 15/931; G06V 20/58; G06N 3/08

(52) U.S. Cl. CPC G08G 1/0965; G01S 15/586; G01S 15/931; G06N 3/08; G06V 20/584; G08G 1/096725

(57) ABSTRACT

An autonomous vehicle includes audio sensors configured to detect audio in an environment around the autonomous vehicle and to generate audio signals based on the detected audio. A processor in the autonomous vehicle receives the audio signals and compares a time domain or frequency domain representation of the audio signals to a corresponding representation of a known emergency vehicle siren. The comparison causes the processor to output a first determination indicating whether the audio signals are indicative of an emergency vehicle siren. The processor also applies a trained neural network to the audio signals that causes the processor to output a second determination indicating whether the audio signals are indicative of the emergency vehicle siren. If the first determination or the second determination indicates presence of an emergency vehicle siren in the environment around the autonomous vehicle, the autonomous vehicle is caused to perform an action.

### CROSS-REFERENCE TO RELATED APPLICATION(S

This application claims the benefit of priority of U.S. Provisional Pat. Application No. 63/238,089, filed on Aug. 27, 2021, which is incorporated by reference in entirety herein.

### TECHNICAL FIELD

The present document relates generally to autonomous vehicles. More particularly, the present document is related to operating an autonomous vehicle (AV) appropriately on public roads, highways, and locations with other vehicles or pedestrians.

### BACKGROUND

One aim of autonomous vehicle technologies is to provide vehicles that can safely navigate towards a destination with limited or no driver assistance. The safe navigation of an autonomous vehicle (AV) from one point to another may include the ability to signal other vehicles, navigating around other vehicles in shoulders or emergency lanes, changing lanes, biasing appropriately in a lane, and navigate all portions or types of highway lanes. Autonomous vehicle technologies may enable an AV to operate without requiring extensive learning or training by surrounding drivers, by ensuring that the AV can operate safely, in a way that is evident, logical, or familiar to surrounding drivers and pedestrians.

### SUMMARY

An autonomous vehicle includes audio sensors configured to detect audio in an environment around the autonomous vehicle and to generate audio signals based on the detected audio. A processor in the autonomous vehicle receives the audio signals and compares a time domain or frequency domain representation of the audio signals to a corresponding representation of a known emergency vehicle siren. The comparison causes the processor to output a first determination indicating whether the audio signals are indicative of an emergency vehicle siren. The processor also applies a trained neural network to the audio signals that causes the processor to output a second determination indicating whether the audio signals are indicative of the emergency vehicle siren. Based on the first determination and the second determination indicating presence of an emergency vehicle siren in the environment around the autonomous vehicle, the autonomous vehicle is caused to perform an action.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a schematic diagram of a system including an autonomous vehicle;

FIG. 2 shows a flow diagram for operation of an autonomous vehicle (AV) safely in light of the health and surroundings of the AV;

FIG. 3 illustrates a system that includes one or more autonomous vehicles, a control center or oversight system with a human operator (e.g., a remote center operator (RCO)), and an interface for third-party interaction;

FIG. 4 is a schematic diagram of an autonomous vehicle according to some implementations;

FIG. 5 is a schematic diagram of an audio sensor array according to some implementations;

FIG. 6 is a block diagram illustrating functional modules executed by an autonomous vehicle to detect emergency vehicle sirens based on audio signals, according to some implementations; and

FIG. 7 is a flowchart illustrating a process for detecting emergency vehicle sirens based on audio signals, according to some implementations.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Vehicles traversing highways and roadways are legally required to comply with regulations and statues in the course of safe operation of the vehicles. For autonomous vehicles (AVs), particularly autonomous tractor trailers, the ability to recognize a malfunction in its systems and stop safely are necessary for lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

In some implementations, an autonomous vehicle includes a plurality of audio sensors configured to detect audio in an environment around the autonomous vehicle and to generate one or more audio signals based on the detected audio. One or more processors in the vehicle receive the audio signals and compare a time domain or frequency domain representation of the one or more audio signals to a corresponding representation of a known emergency vehicle siren. The comparison causes the processor to output a first determination indicating whether the one or more audio signals are indicative of an emergency vehicle siren in the environment around the vehicle. The processor also applies a trained neural network to the audio signals that causes the processor to output a second determination indicating whether the audio signals are indicative of the emergency vehicle siren in the environment around the autonomous vehicle. If either the first determination or the second determination indicates presence of an emergency vehicle siren in the environment around the autonomous vehicle, the autonomous vehicle is caused to perform an action, for example to safely move out of a pathway of the emergency vehicle.

The present document will be further described in detail with reference to the drawings and embodiments. It will be appreciated that the specific embodiments described herein are merely illustrative of the present application and are not to be construed as limiting the present application. In addition, the embodiments and features thereof in the present application may be combined with one another without conflict. It should be further noted that, for the convenience of description, only some, but not all, structures associated with the present application are shown in the drawings.

It should be noted that, before discussing exemplary embodiments in greater detail, some exemplary embodiments are described as processes or methods depicted as flowcharts. Although a flowchart describes steps as sequential processes, many of the steps can be implemented in parallel, concurrently, or simultaneously. In addition, the sequence of the steps can be rearranged. The processes can be terminated when operations thereof are completed, however, additional steps not included in the figure can be comprised herein. The processes can correspond to methods, functions, procedures, subroutines, subprograms, and the like.

It should be noted that the terms “first”, “second”, and the like in the embodiments of the present application are only used for distinguishing between different apparatuses, modules, units, or other objects, and are not used for limiting the sequence of the functions performed by these apparatuses, modules, units, or other objects, or the interdependence of these apparatuses, modules, units, or other objects.

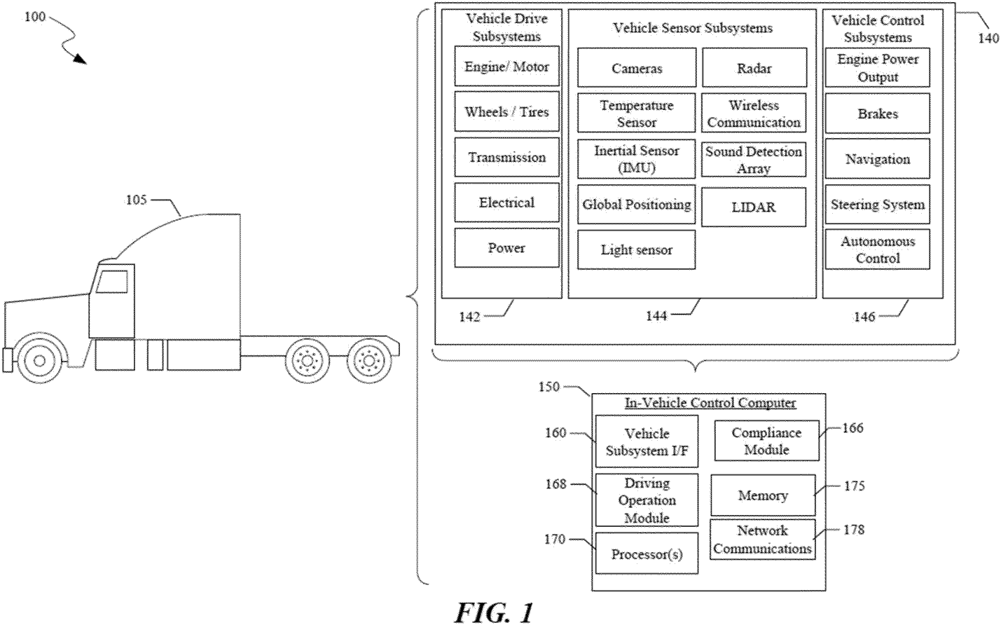

FIG. 1 shows a system 100 that includes a tractor 105 of an autonomous truck. The tractor 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems. An engine or motor, wheels and tires, a transmission, an electrical subsystem, and a power subsystem may be included in the vehicle drive subsystems. The engine of the autonomous truck may be an internal combustion engine, a fuel-cell powered electric engine, a battery powered electrical engine, a hybrid engine, or any other type of engine capable of moving the wheels on which the tractor 105 moves. The tractor 105 have multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the autonomous truck 105, including those which would indicate a malfunction in the AV or another cause for an AV to perform a limited or minimal risk condition (MRC) maneuver. The sensors for general operation of the autonomous vehicle may include cameras, a temperature sensor, an inertial sensor (IMU), a global positioning system, a light sensor, a LIDAR system, a radar system, and wireless communications.

A sound detection array, such as a microphone or array of microphones, may be included in the vehicle sensor subsystem 144. The microphones of the sound detection array are configured to receive audio indications of the presence of, or instructions from, authorities, including sirens and command such as “Pull over.” These microphones are mounted, or located, on the external portion of the vehicle, specifically on the outside of the tractor portion of an autonomous truck 105. Microphones used may be any suitable type, mounted such that they are effective both when the autonomous truck 105 is at rest, as well as when it is moving at normal driving speeds.

Cameras included in the vehicle sensor subsystems 144 may be rear facing so that flashing lights from emergency vehicles may be observed from all around the autonomous truck 105. These cameras may include video cameras, cameras with filters for specific wavelengths, as well as other cameras suitable to detect emergency vehicle lights based on color, flashing, intensity, and/or the like parameters.

The vehicle control subsystem 146 may be configured to control operation of the autonomous vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR (also referred to as LIDAR), the cameras, and/or other vehicle subsystems to determine the driving path or trajectory for the autonomous vehicle 105. The autonomous control that may activate systems that the AV 105 has which are not present in a conventional vehicle, including those systems which can allow an AV to communicate with surrounding drivers or signal surrounding vehicles or drivers for safe operation of the AV.

An in-vehicle control computer 150, which may be referred to as a VCU, includes a vehicle subsystem interface 160, a driving operation module 168, one or more processors 170, a compliance module 166, a memory 175, and a network communications subsystem 178. This in-vehicle control computer 150 controls many, if not all, of the operations of the autonomous truck 105 in response to information from the various vehicle subsystems 140. The one or more processors 170 execute the operations that allow the system to determine the health of the AV, such as whether the AV has a malfunction or has encountered a situation requiring service or a deviation from normal operation and giving instructions. Data from the vehicle sensor subsystems 144 is provided to VCU 150 so that the determination of the status of the AV can be made. The compliance module 166 determines what action should be taken by the autonomous truck 105 to operate according to the applicable (i.e., local) regulations. Data from other vehicle sensor subsystems 144 may be provided to the compliance module 166 so that the best course of action in light of the AV’s status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous Control system. The in-vehicle control computer (VCU) 150 may control the function of the autonomous vehicle 105 based on inputs received from various vehicle subsystems (e.g., the vehicle drive subsystem 142, the vehicle sensor subsystem 144, and the vehicle control subsystem 146). Additionally, the VCU 150 may send information to the vehicle control subsystems 146 to direct the trajectory, velocity, signaling behaviors, and the like, of the autonomous vehicle 105. The autonomous control vehicle control subsystem may receive a course of action to be taken from the compliance module 166 of the VCU 150 and consequently relay instructions to other subsystems to execute the course of action.

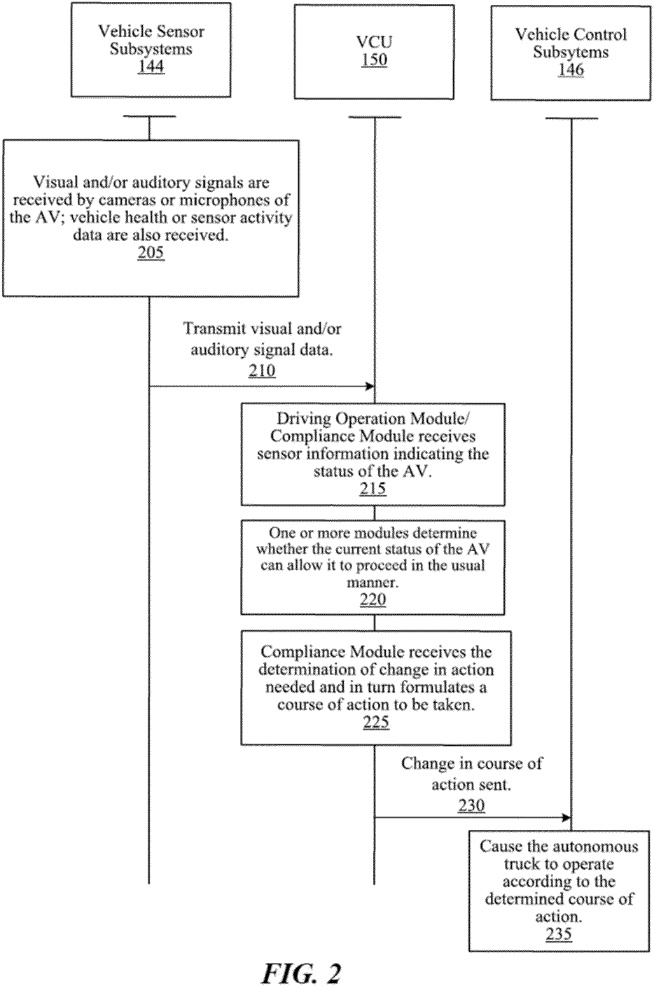

FIG. 2 shows a flow diagram for operation of an autonomous vehicle (AV) safely in light of the health and surroundings of the AV. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

As shown in FIG. 2, the vehicle sensor subsystem 144 receives visual, auditory, or both visual and auditory signals indicating the at the environmental condition of the AV, as well as vehicle health or sensor activity data are received in step 205. These visual and/or auditory signal data are transmitted from the vehicle sensor subsystem 144 to the in-vehicle control computer system (VCU) 150, as in step 210. Any of the driving operation module and the compliance module receive the data transmitted from the vehicle sensor subsystem, in step 215. Then, one or both of those modules determine whether the current status of the AV can allow it to proceed in the usual manner or that the AV needs to alter its course to prevent damage or injury or to allow for service in step 220. The information indicating that a change to the course of the AV is needed may include an indicator of sensor malfunction; an indicator of a malfunction in the engine, brakes, or other components necessary for the operation of the autonomous vehicle; a determination of a visual instruction from authorities such as flares, cones, or signage; a determination of authority personnel present on the roadway; a determination of a law enforcement vehicle on the roadway approaching the autonomous vehicle, including from which direction; and a determination of a law enforcement or first responder vehicle moving away from or on a separate roadway from the autonomous vehicle. This information indicating that a change to the AV’s course of action is needed may be used by the compliance module to formulate a new course of action to be taken which accounts for the AV’s health and surroundings, in step 225. The course of action to be taken may include slowing, stopping, moving into a shoulder, changing route, changing lane while staying on the same general route, and the like. The course of action to be taken may include initiating communications with any oversight or human interaction systems present on the autonomous vehicle. The course of action to be taken may then be transmitted from the VCU 150 to the autonomous control system, in step 230. The vehicle control subsystems 146 then cause the autonomous truck 105 to operate in accordance with the course of action to be taken that was received from the VCU 150 in step 235.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

### Autonomous Truck Oversight System

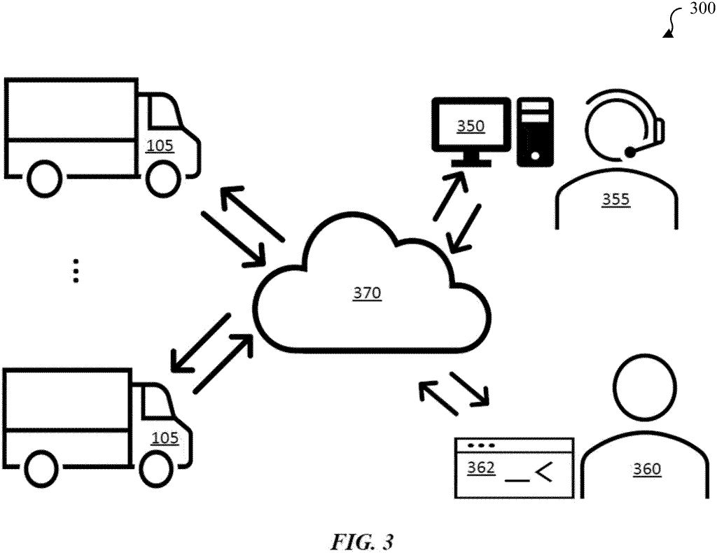

FIG. 3 illustrates a system 300 that includes one or more autonomous vehicles 105, a control center or oversight system 350 with a human operator 355, and an interface 362 for third-party 360 interaction. A human operator 355 may also be known as a remoter center operator (RCO). Communications between the autonomous vehicles 105, oversight system 350 and user interface 362 take place over a network 370. In some instances, where not all the autonomous vehicles 105 in a fleet are able to communicate with the oversight system 350, the autonomous vehicles 105 may communicate with each other over the network 370 or directly. As described with respect to FIG. 1, the VCU 150 of each autonomous vehicle 105 may include a module for network communications 178.

An autonomous truck may be in communication with an oversight system. The oversight system may serve many purposes, including: tracking the progress of one or more autonomous vehicles (e.g., an autonomous truck); tracking the progress of a fleet of autonomous vehicles; sending maneuvering instructions to one or more autonomous vehicles; monitoring the health of the autonomous vehicle(s); monitoring the status of the cargo of each autonomous vehicle in contact with the oversight system; facilitate communications between third parties (e.g., law enforcement, clients whose cargo is being carried) and each, or a specific, autonomous vehicle; allow for tracking of specific autonomous trucks in communication with the oversight system (e.g., third-party tracking of a subset of vehicles in a fleet); arranging maintenance service for the autonomous vehicles (e.g., oil changing, fueling, maintaining the levels of other fluids); alerting an affected autonomous vehicle of changes in traffic or weather that may adversely impact a route or delivery plan; pushing over the air updates to autonomous trucks to keep all components up to date; and other purposes or functions that improve the safety for the autonomous vehicle, its cargo, and its surroundings. An oversight system may also determine performance parameters of an autonomous vehicle or autonomous truck, including any of: data logging frequency, compression rate, location, data type; communication prioritization; how frequently to service the autonomous vehicle (e.g., how many miles between services); when to perform a minimal risk condition (MRC) maneuver while monitoring the vehicle’s progress during the maneuver; when to hand over control of the autonomous vehicle to a human driver (e.g., at a destination yard); ensuring an autonomous vehicle passes pre-trip inspection; ensuring an autonomous vehicle performs or conforms to legal requirements at checkpoints and weight stations; ensuring an autonomous vehicle performs or conforms to instructions from a human at the site of a roadblock, cross-walk, intersection, construction, or accident; and the like.

Included in some of the functions executed by an oversight system or command center is the ability to relay over-the-air, real-time weather updates to autonomous vehicles in a monitored fleet. The over-the-air weather updates may be pushed to all autonomous vehicles in the fleet or may be pushed only to autonomous vehicles currently on a mission to deliver a cargo. Alternatively, or additionally, priority to push or transmit over-the- air weather reports may be given to fleet vehicles currently on a trajectory or route that leads towards or within a predetermined radius of a severe weather event.

Another function that may be encompassed by the functions executed by an oversight system or command center is the transmission of trailer metadata to the autonomous vehicle’s computing unit (VCU) prior to the start of a cargo transport mission. The trailer metadata may include the type of cargo being transmitted, the weight of the cargo, temperature thresholds for the cargo (e.g., trailer interior temperature should not fall below or rise above predetermined temperatures), timesensitivities, acceleration/deceleration sensitivities (e.g., jerking motion may be bad because of the fragility of the cargo), trailer weight distribution along the length of the trailer, cargo packing or stacking within the trailer, and the like.

To allow for communication between autonomous vehicles in a fleet and an oversight system or command center, each autonomous vehicle may be equipped with a communication gateway. The communication gateway may have the ability to do any of the following: allow for AV to oversight system communication (i.e. V2C) and the oversight system to AV communication (C2V); allow for AV to AV communication within the fleet (V2V); transmit the availability or status of the communication gateway; acknowledge received communications; ensure security around remote commands between the AV and the oversight system; convey the AV’s location reliably at set time intervals; enable the oversight system to ping the AV for location and vehicle health status; allow for streaming of various sensor data directly to the command or oversight system; allow for automated alerts between the AV and oversight system; comply to ISO 21434 standards; and the like.

An oversight system or command center may be operated by one or more human, also known as an operator or a remote center operator (RCO). The operator may set thresholds for autonomous vehicle health parameters, so that when an autonomous vehicle meets or exceeds the threshold, precautionary action may be taken. Examples of vehicle health parameters for which thresholds may be established by an operator may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LIDAR, radar, microphone array malfunction); computing resources ability (e.g., VCU or ECU malfunction or lack of responsiveness, temperature abnormalities in computing units); angle between a tractor and trailer in a towing situation (e.g., tractor-trailer, 18-wheeler, or semi-truck); unauthorized access by a living entity (e.g., a person or an animal) to the interior of an autonomous truck; and the like. The precautionary action may include execution of a minimal risk condition (MRC) maneuver, seeking service, or exiting a highway or other such re-routing that may be less taxing on the autonomous vehicle. An autonomous vehicle whose system health data meets or exceeds a threshold set at the oversight system or by the operator may receive instructions that are automatically sent from the oversight system to perform the precautionary action.

The operator may be made aware of situations affecting one or more autonomous vehicles in communication with or being monitored by the oversight system that the affected autonomous vehicle(s) may not be aware of. Such situations may include: irregular or sudden changes in traffic flow (e.g., traffic jam or accident); abrupt weather changes; abrupt changes in visibility; emergency conditions (e.g., fire, sink-hole, bridge failure); power outage affecting signal lights; unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle may be brought to the attention of the oversight system operator through traffic reports, law enforcement communications, data from other vehicles that are in communication with the oversight system, reports from drivers of other vehicles in the area, and similar distributed information venues. An autonomous vehicle may not be able to detect such situations because of limitations of sensor systems or lack of access to the information distribution means (e.g., no direct communication with weather agency). An operator at the oversight system may push such information to affected autonomous vehicles that are in communication with the oversight system. The affected autonomous vehicles may proceed to alter their route, trajectory, or speed in response to the information pushed from the oversight system. In some instances, the information received by the oversight system may trigger a threshold condition indicating that MRC (minimal risk condition) maneuvers are warranted; alternatively, or additionally, an operator may evaluate a situation and determine that an affected autonomous vehicle should perform a MRC maneuver and subsequently send such instructions to the affected vehicle. In these cases, each autonomous vehicle receiving either information or instructions from the oversight system or the oversight system operator uses its on-board computing unit (e.g., VCU) to determine how to safely proceed, including performing an MRC maneuver that includes pulling-over or stopping.

Other interactions that the remote center operator (RCO) may have with an autonomous vehicle or a fleet of autonomous vehicle includes any of the following: pre-planned event avoidance; real-time route information updates; real-time route feedback; trail hookup status; first responder communication request handling; notification of aggressive surrounding vehicle(s); identification of construction zone changes; status of an AV with respect to its operational design domain (ODD), such as alerting the RCO when an autonomous vehicle is close to or enters a status out of ODD; RCO notification of when an AV is within a threshold distance from a toll booth and appropriate instruction/communication with the AV or toll authority may be sent to allow the AV to bypass the toll; RCO notification of when an AV bypasses a toll; RCO notification of when an AV is within a threshold distance from a weigh station and appropriate instruction/communication with the AV or appropriate authority may be sent to allow the AV to bypass the weigh station; RCO notification of when an AV bypasses a weigh station; notification to the AV from the RCO regarding scheduling or the need for fueling or maintenance; RCO authorization of third-party access to an autonomous vehicle cab; ability of an RCO to start/restart an autonomous driving system (ADS) on a vehicle; ability of an administrator (possibly an RCO) to set roles for system users, including ground crew, law enforcement, and third parties (e.g., customers, owners of the cargo); support from a RCO for communication with a service maintenance system with fleet vehicles; notification to the RCO from an AV of acceleration events; instruction from a RCO to an AV to continue its mission even when communication is interrupted; RCO monitoring of an AV during and after an MRC maneuver is executed; support for continuous communication between an AV and a yard operator at facility where the AV is preparing to begin a mission or where the AV is expected to arrive; oversight system monitoring of software systems on an AV and oversight system receiving alerts when software systems are compromised; and the like.

An oversight system or command center may allow a third party to interact with the oversight system operator, with an autonomous truck, or with both the human system operator and an autonomous truck. A third party may be a customer whose goods are being transported, a law enforcement or emergency services provider, or a person assisting the autonomous truck when service is needed. In its interaction with a third party, the oversight system may recognize different levels of access, such that a customer concerned about the timing or progress of a shipment may only be allowed to view status updates for an autonomous truck, or may able to view status and provide input regarding what parameters to prioritize (e.g., speed, economy, maintaining originally planned route) to the oversight system. By providing input regarding parameter prioritization to the oversight system, a customer can influence the route and/or operating parameters of the autonomous truck.

### Features of an Autonomous Driving System in an Autonomous Truck

Actions that an autonomous vehicle, particularly an autonomous truck, as described herein may be configured to execute to safely traverse a course while abiding by the applicable rules, laws, and regulations may include those actions successfully accomplished by an autonomous truck driven by a human. These actions, or maneuvers, may be described as features of the truck, in that these actions may be executable programming stored on the VCU 150 (i.e., the in-vehicle control computer unit). These actions or features may include those related to reactions to the detection of certain types of conditions or objects such as: appropriate motion in response to detection of an emergency vehicle with flashing lights; appropriate motion in response to detecting one or more vehicles approaching the AV, motions or actions in response to encountering an intersection; execution of a merge into traffic in an adjacent lane or area of traffic; detection of need to clean one or more sensor and the cleaning of the appropriate sensor; and the like. Other features of an autonomous truck may include those actions or features which are needed for any type of maneuvering, including that needed to accomplish the features or actions that are reactionary, listed above. Such features, which may be considered supporting features, may include: the ability to maintain an appropriate following distance; the ability to turn right and left with appropriate signaling and motion, and the like. These supporting features, as well as the reactionary features listed above, may include controlling or altering the steering, engine power output, brakes, or other vehicle control subsystems 146.

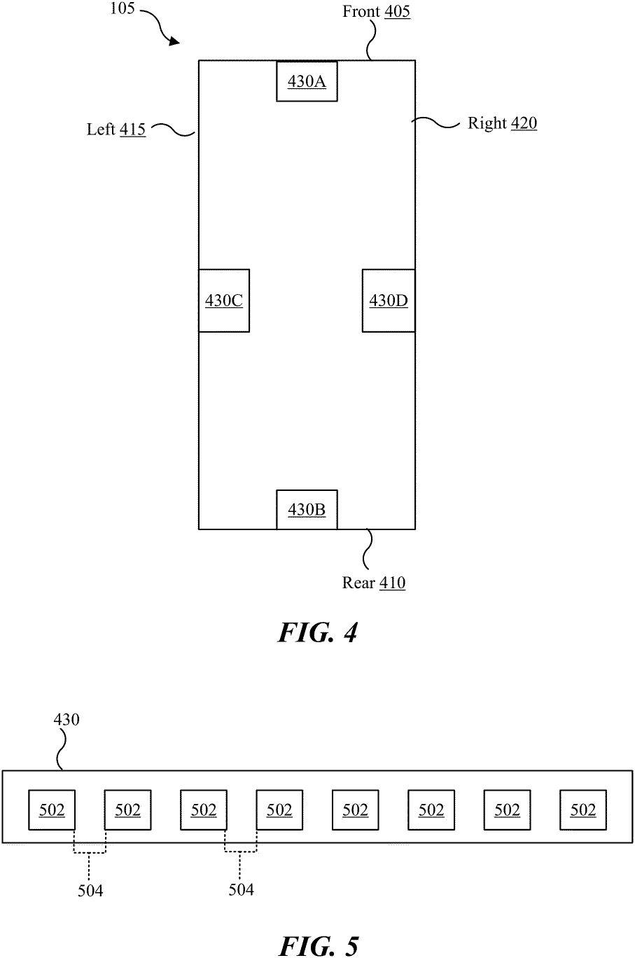

FIG. 4 is a schematic diagram illustrating a configuration of a subset of sensors in the autonomous vehicle 105, according to some implementations. The subset of sensors depicted in FIG. 4 can be part of the vehicle sensor subsystem 144 described with respect to FIG. 1. As shown in FIG. 4, the autonomous vehicle 105 has a front side 405, a rear side 410, a left side 415, and a right side 420. One or more audio sensors can be positioned on each side of the autonomous vehicle, where each audio sensor is configured to generate a respective audio signal based on audio detected in an environment around the autonomous vehicle. For example, an audio sensor array 430 is disposed on each side of the autonomous vehicle. The audio sensor arrays 430 can be positioned on the vehicle at locations that reduce ambient sound caused by wind pressure changes as the autonomous vehicle is operated. For example, each array 430 can be positioned at a location that experiences a lowest wind pressure change during operation of the autonomous vehicle. When the autonomous vehicle 105 is tractor configured to tow a trailer, the audio sensors can be disposed on the tractor, on the trailer, or both. Furthermore, some implementations of the autonomous vehicle 105 further includes one or more sensors configured to detect light signals (such as a camera); the light-detecting sensors in these implementations can similarly be located on the tractor, on the trailer, or both.

FIG. 5 is a schematic diagram illustrating an example audio sensor array 430. The audio sensor array 430 includes multiple audio sensors 502 distributed along a length of the array. In some implementations, the audio sensors 502 have an even spacing distance 504 between adjacent sensors. Alternatively, the audio sensors 502 may be unevenly spaced, e.g., to fit contours of the vehicle.

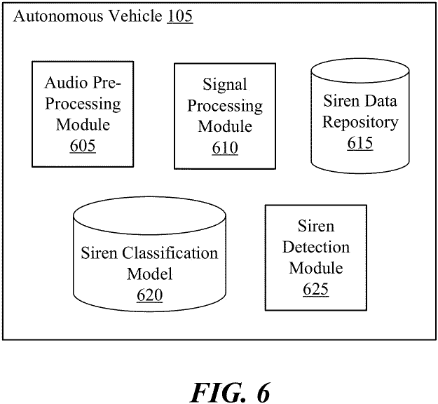

FIG. 6 is a block diagram illustrating functional modules executed by the autonomous vehicle 105 to detect emergency vehicle sirens based on audio signals, according to some implementations. As shown in FIG. 6, the autonomous vehicle 105 can include an audio preprocessing module 605, a signal processing module 610, and a siren detection module 625, as well as store or have access to a siren data repository 615 and a siren classification model 620. The autonomous vehicle 105 can include additional, fewer, or different modules, and functionality described herein can be divided differently between the modules. As used herein, the term “module” refers broadly to software components, firmware components, and/or hardware components. Accordingly, the modules 605, 610, and 625 could each be comprised of software, firmware, and/or hardware components implemented in, or accessible to, the autonomous vehicle 105. In some implementations, the modules 605, 610, and 625 are executed by the in-vehicle control computer 150, for example by the one or more processors 170 executing computer-readable instructions stored in the memory 175.

The audio pre-preprocessing module 605 receives raw audio signals output by the audio sensors and performs one or more pre-processing steps to prepare the audio signals for analysis by other modules. For example, the audio pre-processing module 605 can apply one or more filters or windows to the audio signals to smooth the audio signal or to prepare portions of the audio signal for analysis by the signal processing module 610 or the siren detection module 625.

The audio pre-processing module 605 can also use audio signals generated by some audio sensors in the autonomous vehicle to remove ambient sounds from audio signals generated by other audio sensors in the autonomous vehicle. For example, when the autonomous vehicle 105 is traveling on a limited-access road such as a freeway, an emergency vehicle is expected to approach from either substantially to the front of or substantially to the rear of the vehicle 105. Thus, the audio sensors on the sides of the autonomous vehicle can be used to represent ambient audio in the environment around the autonomous vehicle. The audio pre-processing module 605 uses the signals from the side-facing audio sensors to modify audio signals generated by the forward- and backwardfacing sensors on the autonomous vehicle by removing the ambient audio or portions of the ambient audio (e.g., predominant frequencies).

The signal processing module 610 performs classical signal processing techniques on audio signals, such as the raw audio signals output by the audio sensors or pre-processed audio signals generated by the pre-processing module 605. The output of the signal processing module 610 can include a determination of whether an audio signal matches expected characteristics of an emergency vehicle siren, a prediction of whether the emergency vehicle is approaching or moving away from the autonomous vehicle 105, or an estimation of a position of an emergency vehicle relative to the autonomous vehicle 105.

The signal processing module 610 generates a first determination of whether an audio signal generated by the audio sensors in the autonomous vehicle 105 contains an emergency vehicle siren by comparing a time domain or frequency domain representation of an audio signal to corresponding representations of known sirens. The representations of known sirens can be stored in the siren data repository 615, which can be stored locally on the autonomous vehicle 105 or at a remote location accessible to the vehicle 105. In some implementations, the signal processing module 610 detects and classifies siren sounds as defined by current guidelines issued by relevant jurisdictions, such as US Dept of Justice NIJ Guide 500-00 and SAE J-1849 (including siren patterns for Yelp and Wail), or siren sounds used for civil defense or used to alert the local populations to potential extreme weather or civil defense events as defined by guidelines issue by relevant jurisdictions, such as current FEMA CPG 1-17 and FEMA Manual 1550.2. For example, the signal processing module 610 compares an audio signal detected by the audio sensors on the autonomous vehicle to the predefined siren sounds defined by the guidelines in the jurisdiction in which the vehicle 105 is operating.

In some implementations, the signal processing module 610 performs a frequency analysis of the audio signals to generate a frequency spectrum representing at least a portion of audio. For example, the signal processing module 610 performs a fast Fourier transform on the audio signals to identify predominant frequencies in the signal. The identified predominant frequencies can be compared to predominant frequencies expected for each of several known types of emergency sirens in the siren data repository 615, causing the signal processing module 610 to determine the audio signal contains an emergency siren when at least a threshold degree of match is found. In another example, the autonomous vehicle 105 determines if an average spectrum of the audio signal is within a threshold of an expected average spectrum for an emergency vehicle. Other implementations of the autonomous vehicle 105 analyzes a curve fit of a time-domain representation of an audio signal or performs audio fingerprinting analysis of the audio signal to determine if the sound signal matches expected time domain features of an emergency vehicle’s siren.

The signal processing module 610 can additionally analyze audio signals to determine an angle between the autonomous vehicle 105 and a source of a sound detected by the audio sensors. Based on the known spacing distance 504 between adjacent sensors, some implementations of the signal processing module 610 calculate an angle of incidence of sound on the audio sensor array 430. For example, the autonomous vehicle 105 determines a phase shift angle Φ between the audio signal generated by a first sensor in the array and a second sensor in the array offset by distance d from the first sensor, for a sound signal with frequency λ, and applies the phase shift angle to determine an angle of incidence of the sound signal on the audio sensor array 430 (θ) as follows:

$$Φ = \frac{2 π}{λ} d c o s \left(θ\right)$$

When the sound detected by the audio sensor array 430 is determined to include an emergency vehicle siren, the autonomous vehicle 105 can then calculate an angle between the autonomous vehicle 105 and a source of the siren (presumably an emergency vehicle) by computing a sum of the angle of incidence and the known angle at which the audio sensor array 430 is positioned with respect to the autonomous vehicle.

The signal processing module 610 can additionally or alternatively determine a distance to the source of an audio signal based on a phase or time difference between signals detected at opposite sides of the autonomous vehicle (e.g., at an audio sensor on a left side of the vehicle and an audio sensor on the right side of the vehicle, or at an audio sensor on a front of the vehicle and an audio sensor on a rear of the vehicle). In some implementations, the autonomous vehicle 105 further includes one or more light sensors that are configured to detect emergency vehicle lights, and a difference between a time at which the lights are detected and a time at which the siren sound reaches the autonomous vehicle 105 can be used to estimate the distance to the emergency vehicle.

Some implementations of the signal processing module 610 are further configured to determine whether an emergency vehicle is moving towards or away from the autonomous vehicle 105 by analyzing audio signals for the Doppler effect.

The siren detection module 625 uses the siren classification model 620 and/or the outputs of the signal processing module 610 to detect an emergency vehicle siren in an environment around the autonomous vehicle 105. The siren detection module 625 can take, as input, one or more audio signals and/or features of audio signals generated by the signal processing module 610, and produce as output a determination indicating whether an emergency vehicle siren has been detected.

The siren classification model 620 is a trained machine learning model, such as a neural network, that is trained to classify audio signals or portions of audio signals as either likely to be an emergency vehicle siren or not likely to be an emergency vehicle siren.

A “model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an emergency vehicle siren being nearby based on an analysis of a large set of audio signal data that includes audio signals indicative of and not indicative of the presence of an emergency vehicle siren. Examples of models include: neural networks, support vector machines, decision trees, Parzen windows, Bayes clustering, reinforcement learning, probability distributions, decision trees, decision tree forests, and others. Models can be configured for various situations, data types, sources, and output formats.

In some implementations, the siren classification model 620 can include a neural network with multiple input nodes that receive an input data point or signal, such as a signal received from an audio sensor associated with the autonomous vehicle 105. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer (“the output layer”), one or more nodes can produce a value classifying the input that, once the model is trained, can be used to cause an output in the autonomous vehicle 105. In some implementations, such neural networks, known as deep neural networks, can have multiple layers of intermediate nodes with different configurations, can be a combination of models that receive different parts of the input and/or input from other parts of the deep neural network, or are convolutions - partially using output from previous iterations of applying the model as further input to produce results for the current input.

A machine learning model can be trained with supervised learning, where the training data includes inputs and desired outputs. The inputs can include, for example, the different partial or complete siren sounds generated by different emergency vehicles. Example outputs used for training can include an indication of whether an emergency vehicle was present at the time the training inputs were collected and/or a classification of a type of the emergency vehicle that was present. The desired output (e.g., an indication that an emergency vehicle is present or an indication that an emergency vehicle is not present) can be provided to the model. Output from the model can be compared to the desired output for the corresponding inputs and, based on the comparison, the model can be modified, such as by changing weights between nodes of the neural network or parameters of the functions used at each node in the neural network (e.g., applying a loss function). After applying each of the data points in the training data and modifying the model in this manner, the model can be trained to evaluate new data points (such as new audio signals) to generate the outputs.

The siren classification model 620 can be trained to identify sirens produced by different types of emergency vehicles in different jurisdictions. In general, emergency vehicle sirens include a short sound pattern that is repeated periodically while the siren is activated. The sound pattern produced by a given type of siren in a given jurisdiction may be different from the sound pattern produced by a different type of siren or in a different jurisdiction. For example, the sirens of an ambulance and a police vehicle within the same jurisdiction are typically different from one another. Likewise, ambulances in different countries can have different sirens. An operator of an emergency vehicle can also manually operate the vehicle’s siren (e.g., turning it on and off a few times in short succession), generating a unique audio pattern. Accordingly, the siren classification model 620 can be trained with a training set that includes audio signals produced by an autonomous vehicle’s audio sensors in the presence of different types of sirens and different lengths of siren sound patterns, as well as sirens produced from different angles around the vehicle, different distances from vehicle, and/or at different volumes. The audio signals used for the training data can be audio signals produced by the sensors in the autonomous vehicle 105 in which the trained model is to be deployed, or by sensors in another vehicle or set of vehicles (such as sensors in a test vehicle).

The siren detection module 625 applies the siren classification model 620 to one or more audio signals received from the audio sensors in the vehicle. When applied, the siren classification model 620 outputs a second determination of whether the audio signal is likely indicative of or not indicative of an emergency vehicle siren.

The siren detection module 625 can use the siren classification model 620 to continuously process real-time audio signal while the vehicle is operated. As the data is captured, it can be input to the siren classification model 620 to detect or classify audio signals as either being indicative of or not indicative of a presence of an emergency vehicle

The siren detection module 625 assesses whether an emergency vehicle is likely to be present in the environment of the autonomous vehicle 105 using both the first determination output by the signal processing module 610 and the second determination output based on application of the trained siren classification model 620. If either the first determination or the second determination indicates that an emergency vehicle is present, the siren detection module 625 outputs an alert of the emergency vehicle’s presence that can be used to guide the autonomous vehicle 105 out of the path of the emergency vehicle.

### INTELLIGENT DETECTION OF EMERGENCY VEHICLE SIRENS

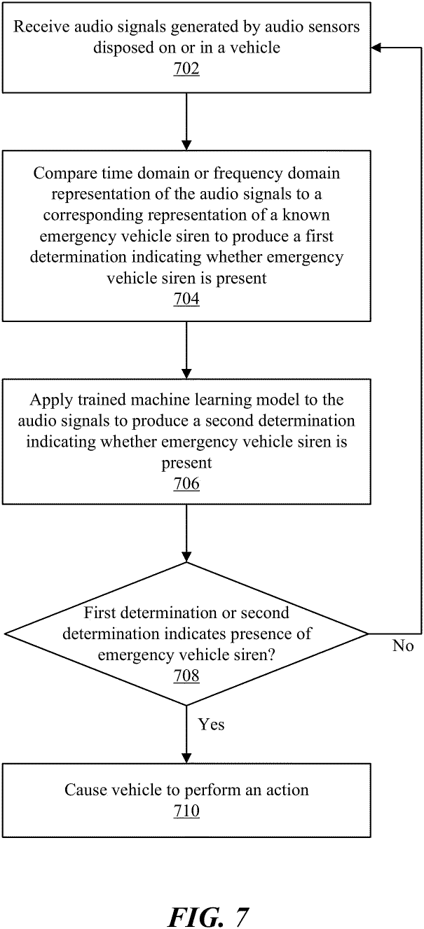

FIG. 7 is a flowchart illustrating a process 700 for detecting emergency vehicles, according to some implementations. The process 700 can be performed by the autonomous vehicle 105, for example by one or more processors in the vehicle 105 executing computer-readable instructions. Other implementations of the process 700 can include additional, fewer, or different steps, and can perform the steps in different orders than shown.

At block 702, the autonomous vehicle 105 receives one or more audio signals generated by respective audio sensors disposed on or in the autonomous vehicle. The audio sensors are configured to detect audio in an environment around the autonomous vehicle and generate the audio signal based on the detected audio.

At block 704, the autonomous vehicle 105 compares a time domain or frequency domain representation of the one or more audio signals to a corresponding representation of a known emergency vehicle siren. The comparison causes the autonomous vehicle 105 to output a first determination indicating whether the one or more audio signals are indicative of an emergency vehicle siren in an environment around the autonomous vehicle.

At block 706, the autonomous vehicle 105 applies a trained machine learning model, such as a neural network, to the one or more audio signals. Applying the trained model causes the processor to output a second determination indicating whether the audio signals are indicative of an emergency vehicle siren in the environment.

Based on the first determination and the second determination each indicating that the audio signals are indicative of an emergency vehicle siren, the autonomous vehicle 105 determines at block 708 if an emergency vehicle siren is present. In some cases, the autonomous vehicle 105 decides the emergency vehicle siren is present if either the first determination or the second determine indicates the audio signals are indicative of an emergency vehicle siren in the environment around the autonomous vehicle. In other cases, the autonomous vehicle 105 processes the first determination and second determinations as binary values, where a value of 0 indicates an emergency vehicle siren is not present and a value of 1 indicates a siren is present. At decision block 708, the autonomous vehicle 105 computes a weighted sum of the first and second determinations. If the weighted sum exceeds a specified threshold (e.g., 0.5), the autonomous vehicle 105 determines an emergency vehicle siren has been detected. The weights applied in the weighted sum can be configurable fixed weights or weights that are dynamically generated based on, for example, a duration of the captured audio signal that is being evaluated.

If, at decision block 708, the autonomous vehicle 105 determines an emergency vehicle siren is present, the autonomous vehicle 105 performs an action at block 710. For example, a vehicle control system causes the autonomous vehicle 105 to slow or pull to a side of the road to allow the emergency vehicle to pass. As another example, in implementations where the autonomous vehicle 105 is not operated fully autonomously, an alert can be output to a driver of the autonomous vehicle to navigate the autonomous vehicle to the side of the road or away from the path of the emergency vehicle.

In some cases, the autonomous vehicle 105 determines a distance to the source of the emergency vehicle siren based, for example, on a difference between audio signals detected on opposite sides of the autonomous vehicle or based on a difference between when an emergency vehicle light pattern was detected and when the emergency vehicle siren was detected. The autonomous vehicle 105 can also determine whether the source of the siren is moving towards or away from the autonomous vehicle 105. When the direction of and distance to the source of the siren is calculated, the autonomous vehicle may not take the action at block 710 unless the emergency vehicle is moving towards the autonomous vehicle 105, and/or the emergency vehicle is within a threshold distance of the autonomous vehicle 105. The threshold distance can be calculated based on the time estimated for the autonomous vehicle 105 to move out of a pathway of an approaching emergency vehicle. For example, the threshold distance can be calculated as the distance needed at a typical vehicle velocity for the autonomous vehicle to clear a complex intersection and pull over to make way for an approaching emergency vehicle travelling at 90 MPH (40.23 meters/second) with sirens enabled, approaching the same intersection.

The autonomous vehicle’s use of both machine learning-based siren detection and time domain- or frequency domain-based detection enables the autonomous vehicle to more accurately identify sirens based on audio signals. For example, the time domain- or frequency domain-based methods may be more accurate than a trained model when detecting sirens that are allowed to run continuously across multiple periods of the siren’s sound pattern, for well-known sound patterns. On the other hand, the trained model may be more accurate when the autonomous vehicle encounters a new type of siren or when the siren is manually operated in short bursts that are shorter than the period of the siren’s sound pattern. Thus, by combining these techniques, the autonomous vehicle 105 can more readily ensure that it correctly detects the presence of an emergency vehicle siren and takes appropriate action in response.

### REMARKS

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. An autonomous vehicle, comprising:
a plurality of audio sensors configured to detect audio in an environment around the autonomous vehicle and to generate audio signals based on the detected audio;
one or more processors; and
a non-transitory computer-readable storage medium storing executable instructions, the instructions when executed by the one or more processors causing the one or more processors to:
compare a time domain or a frequency domain representation of the audio signals to a corresponding representation of a known emergency vehicle siren, wherein the comparison outputs a first determination indicating whether the audio signals are indicative of an emergency vehicle siren in the environment around the autonomous vehicle;
apply a trained neural network to the audio signals, the trained neural network causing the one or more processors to output a second determination indicating whether the audio signals are indicative of the emergency vehicle siren in the environment around the autonomous vehicle; and
based on the first determination and the second determination each indicating the audio signals are indicative of an emergency vehicle siren in the environment around the autonomous vehicle, cause the autonomous vehicle to perform an action.

2. The autonomous vehicle of claim 1, wherein the plurality of audio sensors comprise:
a first audio sensor on a front side of the autonomous vehicle and configured to generate a first audio signal;
a second audio sensor on a rear side of the autonomous vehicle and configured to generate a second audio signal;
a third audio sensor on a left side of the autonomous vehicle and configured to generate a third audio signal; and
a fourth audio sensor on a right side of the autonomous vehicle and configured to generate a fourth audio signal.

3. The autonomous vehicle of claim 2, wherein the instructions when executed by the one or more processors further cause the one or more processors to:
generate, based on the third audio signal or the fourth audio signal, a representation of ambient audio in the environment of the autonomous vehicle; and
modify the first audio signal or the second audio signal based on the representation of the ambient audio;
wherein the trained neural network is applied to the modified first audio signal or the modified second audio signal.

4. The autonomous vehicle of claim 2, wherein the instructions when executed by the one or more processors further cause the one or more processors to, in response to the first determination or the second determination indicating the audio signals are indicative of the emergency vehicle siren in the environment around the autonomous vehicle:
generate a comparison between the third audio signal and the fourth audio signal; and
detect a direction from the autonomous vehicle to an emergency vehicle producing the emergency vehicle siren based on the comparison between the third audio signal and the fourth audio signal.

5. The autonomous vehicle of claim 1, wherein the plurality of audio sensors comprises an audio sensor array that includes a set of audio sensors distributed along a length of the audio sensor array, and wherein the instructions when executed by the one or more processors further cause the one or more processors to:
receive a first audio signal generated by a first audio sensor in the audio sensor array in response to a sound incident on the audio sensor array;
receive a second audio signal generated by a second audio sensor in the audio sensor array;
determine a phase shift angle between the first audio signal and the second audio signal;
calculate an angle of incidence of the sound on the audio sensor array based on the phase shift angle and a distance between the first audio sensor and the second audio sensor; and
in response to the second determination output by the trained neural network when applied to the first audio signal or the second audio signal indicating presence of the emergency vehicle siren in the environment around the autonomous vehicle, determine an angle between the autonomous vehicle and a source of the emergency vehicle siren based on the angle of incidence of the sound on the audio sensor array.

6. The autonomous vehicle of claim 1, further comprising:
a camera configured to detect light signals in the environment around the autonomous vehicle;
wherein the instructions when executed by the one or more processors further cause the one or more processors to, in response to the first determination or the second determination indicating the audio signals are indicative of the emergency vehicle siren in the environment around the autonomous vehicle:
process the light signals detected by the camera to identify an emergency vehicle light pattern; and
determine a distance between the autonomous vehicle and an emergency vehicle producing the emergency vehicle siren based on a difference between an arrival time of the emergency vehicle light pattern at the camera and an arrival of the detected audio determined to indicate the emergency vehicle siren.

7. A method comprising:
receiving, at a processor associated with a vehicle, one or more audio signals generated by respective audio sensors disposed on or in the vehicle;
comparing, by the processor, a time domain or frequency domain representation of the one or more audio signals to a corresponding representation of a known emergency vehicle siren, wherein the comparison outputs a first determination indicating whether the one or more audio signals are indicative of an emergency vehicle siren in an environment around the vehicle;
applying, by the processor, a trained neural network to the one or more audio signals, the trained neural network causing the processor to output a second determination indicating whether the audio signals are indicative of the emergency vehicle siren in the environment around the vehicle; and
based on the first determination and the second determination indicating the audio signals are indicative of an emergency vehicle siren in the environment around the vehicle, causing the vehicle to perform an action.

8. The method of claim 7, wherein the trained neural network is trained using a set of training audio signals generated by test audio sensors in response to a plurality of different types of sirens output by different types of emergency vehicles.

9. The method of claim 8, wherein each of the plurality of different types of sirens has a corresponding periodic siren sound pattern, and wherein the set of training audio signals include a subset of audio signals generated by the test audio sensors in response to a plurality of siren segments that represent different portions of each periodic siren sound pattern.

10. The method of claim 8, wherein the set of training audio signals include a subset of audio signals generated by the test audio sensors in response to:
a plurality of emergency vehicle sirens produced at different volumes;
a plurality of emergency vehicle sirens produced at different distances from the test audio sensors; or
a plurality of emergency vehicle sirens produced from different angles around the test audio sensors.

11. The method of claim 7, wherein comparing the time domain or frequency domain representation of the one or more audio signals to the corresponding representation of a known emergency vehicle siren comprises:
computing a frequency spectrum of the one or more audio signals; and
comparing the computed frequency spectrum to one or more frequency spectra of known sirens stored in a data repository available to the processor.

12. The method of claim 7, wherein comparing the time domain or frequency domain representation of the one or more audio signals to the corresponding representation of a known emergency vehicle siren comprises:
performing a curve fit on a time domain representation of the one or more audio signals; and
comparing features of the curve fit to corresponding curve fit features of known sirens stored in a data repository available to the processor.

13. The method of claim 7, further comprising, in response to the first determination or the second determination indicating the audio signals are indicative of an emergency vehicle siren in the environment around the vehicle:
detecting a distance between the vehicle and a source of the emergency vehicle siren;
wherein the vehicle is caused to perform the action when the detected distance is less than a threshold distance.

14. The method of claim 7, further comprising, in response to the first determination or the second determination indicating the audio signals are indicative of an emergency vehicle siren in the environment around the vehicle:
detecting a Doppler effect-based change to the emergency vehicle siren; and
determining whether a source of the emergency vehicle siren is moving towards or away from the vehicle;
wherein the vehicle is caused to perform the action when the source of the emergency vehicle siren is determined to be moving towards the vehicle.

15. The method of claim 7, wherein causing the vehicle to perform the action comprises causing the vehicle to navigate out of a path of an emergency vehicle producing the emergency vehicle siren.

16. A non-transitory computer-readable storage medium storing executable instructions, the instructions when executed by one or more processors associated with a vehicle causing the one or more processors to:
receive one or more audio signals generated by respective audio sensors disposed on or in the vehicle;
compare a time domain or frequency domain representation of the one or more audio signals to a corresponding representation of a known emergency vehicle siren, wherein the comparison outputs a first determination indicating whether the one or more audio signals are indicative of an emergency vehicle siren in an environment around the vehicle;
apply a trained neural network to the one or more audio signals, the trained neural network causing the processor to output a second determination indicating whether the audio signals are indicative of the emergency vehicle siren in the environment around the vehicle; and
based on a weighted sum of the first determination and the second determination, cause the vehicle to perform an action.

17. The non-transitory computer-readable storage medium of claim 16, wherein the instructions when executed by the one or more processors further cause the one or more processors to:
receive a first audio signal generated by an audio sensor disposed at a front or a rear of the vehicle;
receive a second audio signal generated by an audio sensor disposed at a left side or a right side of the vehicle;
generate, based on the second audio signal, a representation of ambient audio in the environment of the vehicle; and
modify the first audio signal based on the representation of the ambient audio;
wherein the trained neural network is applied to the modified first audio signal.

18. The non-transitory computer-readable storage medium of claim 16, wherein the instructions when executed by the one or more processors further cause the one or more processors to:
receive a first audio signal generated by an audio sensor disposed at a left side of the vehicle;
receive a second audio signal generated by an audio sensor disposed at a right side of the vehicle;
generate a comparison between the first audio signal and the second audio signal; and
detect a direction from the vehicle to an emergency vehicle producing the emergency vehicle siren based on the comparison between the first audio signal and the second audio signal.

19. The non-transitory computer-readable storage medium of claim 16, wherein the trained neural network is trained using a set of training audio signals generated by test audio sensors in response to a plurality of different types of sirens output by different types of emergency vehicles, the set of training audio signals including:
a subset of audio signals generated by the test audio sensors in response to a plurality of siren segments that represent different portions of periodic siren sound patterns;
a subset of audio signals generated by the test audio sensors in response to a plurality of emergency vehicle sirens produced at different volumes;
a subset of audio signals generated by the test audio sensors in response to a plurality of emergency vehicle sirens produced at different distances from the test audio sensors; or
a subset of audio signals generated by the test audio sensors in response to a plurality of emergency vehicle sirens produced from different angles around the test audio sensors.

20. The non-transitory computer-readable storage medium of claim 16, wherein the instructions when executed by the one or more processors further cause the one or more processors to, in response to the first determination or the second determination indicating the audio signals are indicative of an emergency vehicle siren in the environment around the vehicle:
detecting a distance between the vehicle and an emergency vehicle producing the emergency vehicle siren;
wherein causing the vehicle to perform the action comprises causing the vehicle to navigate out of a path of the emergency vehicle when the detected distance is less than a threshold distance.
